(19) United States
(12) Patent Application Publication
(10) Pub. No.: US 2009/0044905 A1
(43) Pub. Date: Feb. 19, 2009

(54) METHOD OF PROVIDING GRAPHICS TO A SPORTS BOARD

(76) Inventors: Scott Burke, Oceanside, CA (US); Aifu Shen, Zhejiang (CN)

Correspondence Address: STEVEN VOSEN, 1563 SOLANO AVENUE #206, BERKELEY, CA, 94707, US

(21) Appl. No.: 12/045,922

(22) Filed: Mar. 11, 2008

Related U.S. Application Data
(63) Continuation-in-part of application No. 11/710,497, filed on Feb. 26, 2007.
(60) Provisional application No. 60/943,529, filed on Jun. 12, 2007.

(30) Foreign Application Priority Data
May 12, 2006 (CN) 200620113932.8
Sep. 1, 2006 (CN) 200610112336.2
Feb. 6, 2007 (CN) 200710003414.X

(51) Int. Cl. B32B 37/06

(52) U.S. Cl. 156/272.6

(57) ABSTRACT

A method of providing a sports board with graphics is described. The method includes providing a graphics layer to the outer surface of the sports board. In one embodiment, the graphics layer is roller printed on a polyethylene film, which is affixed to a foam core. In another embodiment, a fabric, which may be a non-woven material and which may have another graphics layer, is provided to the back side of the foam core.

### CROSS-REFERENCE TO RELATED APPLICATIONS

This application is a continuation-in-part of application Ser. No. 11/710,497, filed Feb. 26, 2007, which claims priority under 35 U.S.C. 119 to Chinese Patent Application No. 200710003414.X, filed Feb. 6, 2007, Chinese Patent Application No. 200610112336.2, filed Sep. 1, 2006, and Chinese Patent Application No. 200620113932.8, filed May 12, 2006. This application also claims the benefit of U.S. Provisional Application No. 60/943,529 filed Jun. 12, 2007. The entire contents of each of the listed patent applications are hereby incorporated by reference herein and made part of this specification.

### BACKGROUND OF THE INVENTION

1. Field of the Invention

The present invention generally relates to methods of making sports boards, and more particularly to a method for making a sports board having graphic designs.

2. Discussion of the Background

Sports boards are popular and widely known for providing recreational entertainment in both warm and cold weather environments. Sports boards are often composed of a foam core, plastic film skins on the top, and a thick slick plastic bottom surface layer.

Typically, sports boards also include a graphics layer and a clear layer laminated over the graphics layer, forming the top and/or bottom of the board. It may be desirable to form boards having simplified graphics layer structure to reduce the cost and time required to manufacture sports boards.

### BRIEF SUMMARY OF THE INVENTION

The present invention overcomes the disadvantages of prior art by providing a graphics layer to a sports board that is easily and inexpensively applied to the board.

In certain embodiments, a method is provided for applying a graphics to an outer surface of a sports board having a foam core. The core may be, for example and without limitation, polyethylene, and expanded polystyrene, or polypropylene core. The method includes providing a graphics layer to a first surface of a film, where the film has a second surface opposing the first surface; and joining the second surface of the film to the foam core. In one embodiment, the providing includes roller printing the graphics layer to the first surface. In another embodiment, a coronal treating of the film is provided before printing.

It is one aspect to provide a method of providing graphics to a sports board having a foam core, where the foam core has a first side and an opposing second side. The method includes providing a graphics layer to a first surface of a material, where the material has a second surface opposing the first surface, and joining the second surface of the material to the first side of the foam core. The graphics layer forms at least part of an outer surface of the sports board. In one embodiment, the providing includes roller printing the graphics layer to the first surface. In another embodiment, the method further includes coronal treating the first surface prior to roller printing the film. In yet another embodiment, the material includes a polyethylene film.

It is another aspect to provide a method providing graphics to a sports board having a foam core, where the foam core has a first side and an opposing second side. The method includes joining a material to a front side of the foam core, where the material includes a first graphics layer facing away from the foam core, and joining a fabric to a back side of the foam core, where the fabric includes a second graphics layer facing away from the foam core. The first graphics layer forms at least part of an outer surface of the sports board. In one embodiment, the fabric is a non-woven material.

Described herein include methods of making sports boards. The described features together with the various ancillary provisions and features which will become apparent to those skilled in the art from the following detailed description, are attained by the sports board with graphics and methods for making the sports board, embodiments thereof being shown with reference to the accompanying drawings, by way of example only, wherein:

### BRIEF DESCRIPTION OF THE SEVERAL VIEWS OF THE DRAWING

FIG. 1 is a top view of an embodiment of a sports board;

FIG. 2 is a sectional view 2-2 of a sports board;

FIG. 3A is a schematic sectional view 3-3 of a first embodiment of a sports board;

FIG. 3B is an exploded sectional view 3-3 of a first embodiment of a sports board;

FIG. 4 is a sectional view 3-3 of a second embodiment of a sports board;

FIG. 5 is a sectional view 3-3 of a third embodiment of a sports board;

FIG. 6 is a flowchart of one embodiment of a method for manufacturing the sports board of FIG. 4;

FIG. 7 is a flowchart of one embodiment of a method for manufacturing the sports board of FIG. 5;

FIG. 8 is a schematic illustrating the process and manufacturing equipment to accepts a roll of a material, treat the material and apply a graphics layer on one side of the material, and wind the material supporting graphics layer into a roll;

FIG. 9 is a schematic illustrating the process and manufacturing equipment to accepts a roll of a material, apply a graphics layer on one side of the material, and wind the material supporting graphics layer into a roll;

FIG. 10 is a schematic illustrating the process and manufacturing equipment to accept a roll of material, apply a layer of adhesive to both sides of the material, and wind the material with adhesive layers into a roll;

FIG. 11 is a schematic illustrating the process and manufacturing equipment to join two materials and to roll the joined surface;

FIG. 12 is a schematic illustrating the process and manufacturing equipment to join three materials and to roll the joined surface;

FIG. 13 is a schematic illustrating the process and manufacturing equipment to accept a roll and form a top layer;

FIG. 14 is a schematic illustrating the process and manufacturing equipment to accept a roll and form a bottom layer;

FIG. 15 is a schematic illustrating the process and manufacturing equipment to join the top layer to the core;

FIG. 16 is a schematic illustrating the process and manufacturing equipment to join the bottom layer to the core; and

FIGS. 17A, 17B, and 17C are three consecutive schematics illustrating the process and manufacturing equipment to accept rolls of material and form a board.

Reference symbols are used in the Figures to indicate certain components, aspects or features shown therein, with reference symbols common to more than one Figure indicating like components, aspects or features shown therein.

### DETAILED DESCRIPTION OF THE INVENTION

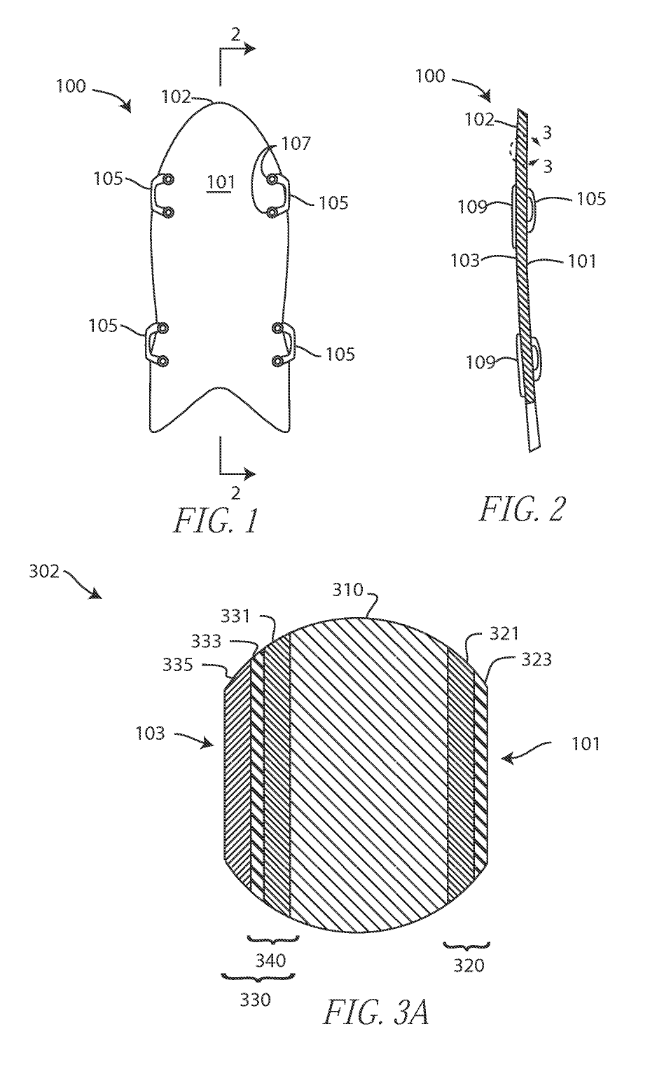

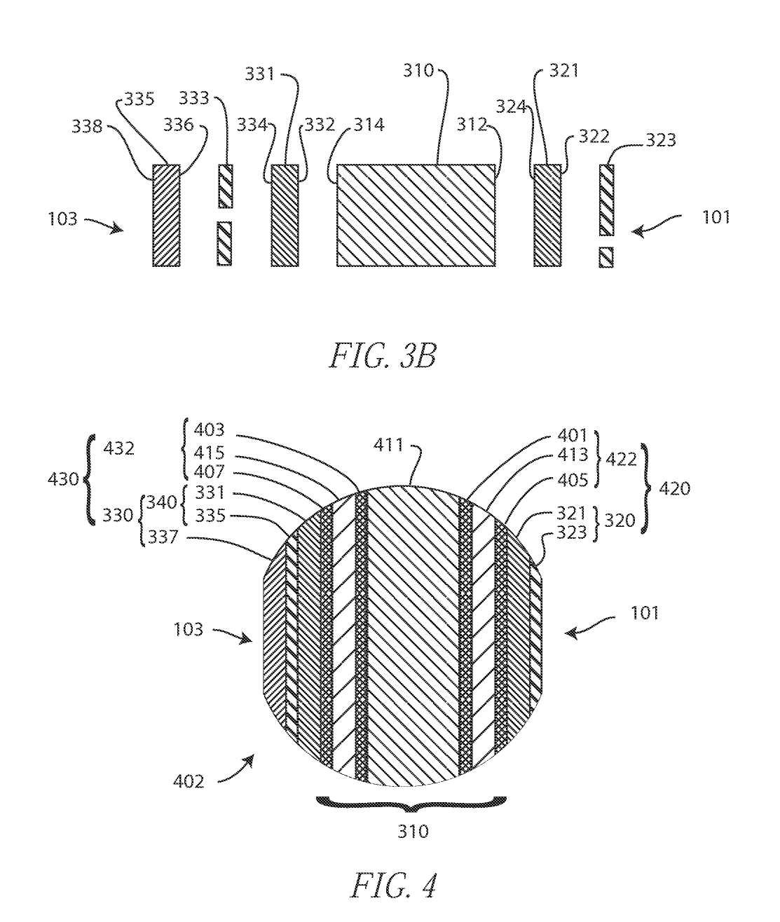

FIG. 1 is an embodiment of a sports board 100, which includes a board 102 having a top surface 101 and a bottom surface 103. FIG. 2 is a sectional view 2-2 of FIG. 1, and FIG. 3 is a detailed sectional view 3-3 of FIG. 2. In various embodiments, sports board may be used, for example, for gliding over the snow or a slippery surface, or may be used to float on water. Sports board 100 includes handles 105 that are fastened to board 102 using pins 107 and which are accessible from top surface, and rails 109 that protrude from bottom surface 103. Methods for attaching or incorporating rails and handles into sports boards and known in the art. In the embodiment of FIGS. 1 and 2, handles 105, pins 107, and rails 109 are formed from high-density polyethylene (HDPE).

Board 102 includes top and bottom layers that may include graphics. Thus, for example, board 102 may include one or more foam and/or plastic materials and markings which may include printed or transferred graphic images that are visible on top surface 101 or bottom surface 103. In several embodiments, board 102 includes a core between a top layer and a bottom layer, where one or both of the top or bottom layers support graphics visible from top surface 101 or bottom surface 103. In one embodiment, a graphic layer is covered with a clear layer which may, for example form one or both of top surface 101 or bottom surface 103. In another embodiment, a graphics layer is printed directly onto top surface 101 or bottom surface 103. In another embodiment, top surface 101 includes a graphics layer, and bottom surface 103 may, but is not required to include, a graphics layer that is covered with a clear layer.

Board 102 may include one or more foam portions. Examples of foam material include, but are not limited to, one or more of polyethylene, cross-linked polyethylene, expanded polyethylene, expanded polystyrene, polypropylene, or a polyethylene/expanded polystyrene blend. The density of the foam portions of board 102 may be from approximately 0.75 pounds per cubic foot to approximately 10 pounds per cubic foot, and have a thickness of from approximately 1 mm to approximately 125 mm. Board 102 may also include materials covering the one or more foam portions. The covering material may include, but is not limited to, one or more of a polyethylene layer or a fabric formed of natural and/or synthetic materials and has a thickness of from 0.01 mm to approximately 2 mm.

FIG. 3A is a schematic sectional view of a first embodiment of a board 302, and FIG. 3B is an exploded view of board 302. Board 302 may be generally similar to board 102, except as further detailed below. Where possible, similar elements are identified with identical reference numerals in the depiction of the embodiments of FIGS. 1, 2, 3A and 3B.

Board 302 is a laminated structure that includes a core 310, a top layer 320 (also referred to herein as a “deck”) and a bottom layer 330 (also referred to herein as a “slick”). In various embodiments, core 310, top layer 320, and bottom layer 330 may also include one or more layers, including but not limited to foam layers.

In the embodiment of FIGS. 3A and 3B, core 310 has one or more layers of foam with a top surface 312 and a bottom surface 314. More specifically, core 310 in one embodiment is single layer core, and in another embodiment is a multi-layer core. Top layer 320 includes a layer of a film 321 and a graphics layer 323, where film 321 has an inner surface 324 that faces core top surface 312 and an outer surface 322 that supports graphics layer 323. A bottom printed layer 340 includes a fabric layer 331 that supports a graphics layer 333. A bottom layer 330 includes bottom printed layer 340 and a clear layer 335. More specifically, fabric layer 331 has an inner surface 332 that faces core bottom surface 314 and an outer surface 334 that supports a graphics layer 333, and clear layer 335 has an outer layer 338 and an inner surface 336 that faces graphics layer 333 and fabric layer 331.

Core 310, film 321, fabric 331 and clear layer 323 may include, but are not limited to, one or more plastic materials having the structure of a film, a sheet, or a foam, and may include plastic fibers or other materials, such as natural fibers. Graphics layers 323 and 333 include inks that are transferred to and which may cover some or all of the supporting surfaces, and which may require surface treating before being transferred. As shown in FIGS. 3A and 3B, clear film inner surface 336 may contact graphics layer 333 and may also contact fabric outer surface 334. Graphics layer 323 and any portion of film out surface 322 that does not support graphics may form top surface 101.

The facing surfaces of board 302 may be joined using techniques appropriate for the physical and chemical properties of the various layers and which are know in the art. Thus, for example and without limitation, surfaces 312 and 324, surfaces 314 and 332, and graphics layer 333 or surface 334 and surface 336 may be joined using an adhesive or resin layer, or joined directly by heating and fusing the layer materials. In one embodiment, a resin, such as an ethylene vinyl acetate resin, is extruded on one of the surfaces to be joined, and the resin is heated prior to compressing the surfaces together. Alternatively, a polyethylene layer may be used to join surfaces. In yet another embodiment, a layer may be joined to the adjoining layer by heating and extruded one layer material onto the adjoining layer surface. It is to be understood that the illustration or discussion of the application of an adhesive layer is optional for materials that can be forced to bond directly to one another.

FIG. 4 is a second embodiment of a board 402, which may be generally similar to boards 102 or 302, except as further detailed below. Where possible, similar elements are identified with identical reference numerals in the depiction of the embodiments of FIGS. 1, 2, 3A, 3B, and 4.

Core 310 of board 402 is a multi-layered foam core, including a center foam material 411, a top foam material 413 and a bottom foam material 415. Foam materials 413 and 415 are sometimes referred to herein as “backing foams.” Center foam material 411 is joined to top foam material 413 with an adhesive 401 and is joined to bottom foam material 415 with an adhesive 403. Top portion 320 is joined to top foam material 413 with an adhesive 405, and bottom portion 330 is joined to bottom foam material 415 with an adhesive 407. Alliteratively, for surfaces that may be fused directly, such as polyethylene, adhesive layers are optional.

Also shown in FIG. 4 is a layer 422 including adhesive 401, top foam material 413, and adhesive 405, a top layer 420 including top portion 320 and layer 422, a layer 432 including adhesive 403, bottom foam material 415 and adhesive 407, and a bottom layer 430 including bottom portion 330 and layer 432.

The following embodiment is illustrative of the structure of board 402, and is not meant to limit the scope of the present invention. In one embodiment, center foam material 411 is a foam with a density of from approximately 0.75 pounds per cubic foot to approximately 4 pounds per cubic foot. Center foam material 411 may be an expanded polyethylene, expanded polystyrene, polypropylene, or a polyethylene/expanded polystyrene blend. The thickness of foam material 411 (that is, distance between materials 413 and 415) may be from approximately 10 mm to approximately 125 mm.

Top foam material 413 and bottom foam material 415, may have the same or different materials or dimensions. The density of either one of materials 413 or 415 is from approximately 1 pound per cubic foot to approximately 10 pounds per cubic foot. The material of either one of materials 413 of 415 may be a polyethylene or a cross-linked polyethylene. The thickness of either one of materials 413 or 415 is from approximately 1 mm to approximately 5 mm.

In one embodiment, film 321 is a layer of polyethylene having a thickness of from approximately 0.01 mm to approximately 2 mm. Graphics layer 323 is formed by roller printing on film 321, where the graphics receiving side of the film first undergoes a coronal treatment to facilitate the adherence of ink on the film.

Fabric layer 331 is a non-woven material, which may be formed for example, formed from polyester fibers (one such material is NEXUS™, Precision Fabrics Group, Greensboro, N.C.). In one embodiment, fabric layer 331 is from 2 to 10 mils thick. Graphics layer 333 is a forward printed ink image. Clear layer 335 is layer of polyethylene, such as a low density polyethylene or a high density polyethylene, with a thickness of from approximately 0.01 mm to approximately 2 mm. For joining a layer to an expanded polystyrene material, an ethylene vinyl acetate resin may be used for adhesive 401, 403, 405 and 407. Ethylene vinyl acetate resin will bond to expanded polystyrene upon the application of heat and pressure.

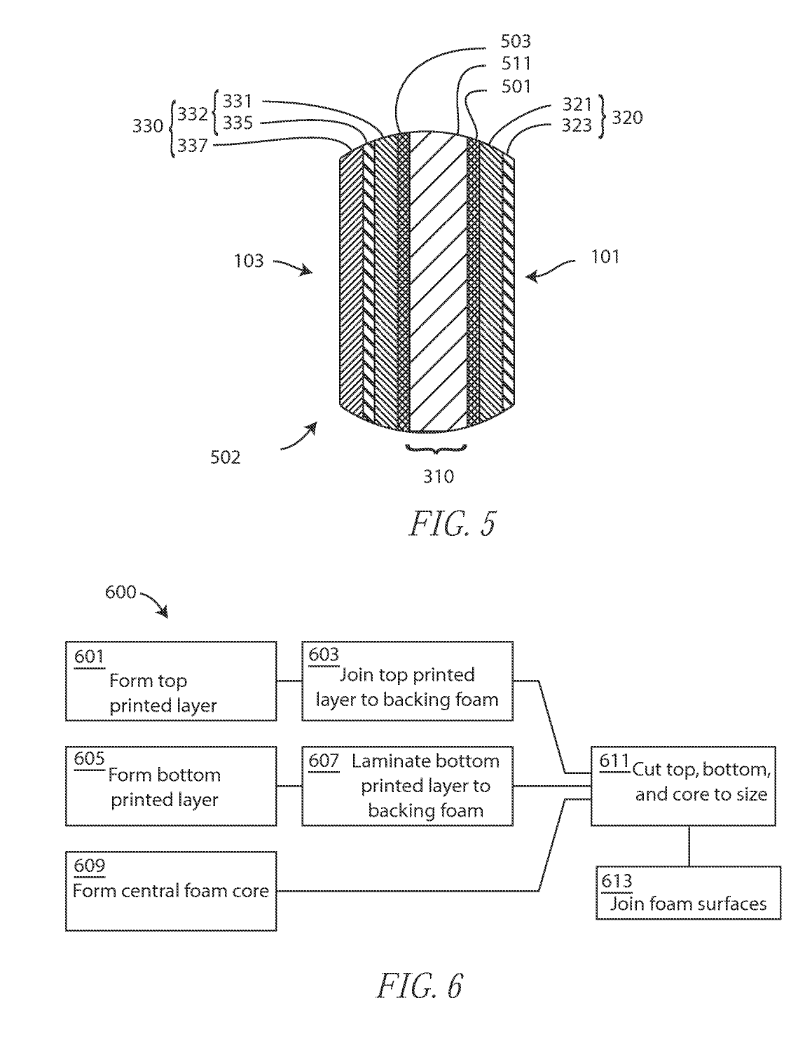

FIG. 5 is a third embodiment of a board 502, which may be generally similar to boards 102, 302, or 402, except as further detailed below. Where possible, similar elements are identified with identical reference numerals in the depiction of the embodiments of FIGS. 1, 2, 3A, 3B, 4, and 5.

Core 310 of board 502 is a single layer foam core, including a foam material 511. Foam material 511 is joined to top layer 320 with an adhesive 501 and is joined to bottom layer 330 with an adhesive 503. In one embodiment, material 511 is similar in material, density, and dimensions to material 413 or 415, and adhesive 501, and 503, if required, are similar to adhesive 401, 403, 405 and 407, as described previously. Alliteratively, for surfaces that may be fused directly, such as polyethylene, adhesive layers are optional.

FIG. 6 is a flowchart 600 illustrating one method of manufacturing board 402. The method includes several laminating steps. In Block 601 top layer 320 is formed. In Block 603 top layer 320 is joined to a backing foam (such as top foam material 413). In Block 605 bottom printed layer 340 is formed. In Block 607 bottom printed layer is joined to a backing foam (such as bottom foam material 415). In Block 609 center foam material 411 is formed. In Block 611 the various portions are cut to size. In Block 613 the foam surfaces are joined. The order of some of these steps may be rearranged in the manufacture of board 402.

One embodiment of flowchart 600 will now be presented with reference to FIGS. 8, through 16, which schematically show methods and equipment used to form the various layers and final board 402. It is understood that this embodiment is one method of manufacturing board 402, and other steps, combinations of steps, or order of steps are within the scope of the present invention. The following description discusses embodiments in which rolls of material is processed. The processing of rolls of materials, including transporting, rolling, unrolling, tensioning, printing, heating, cooling, and otherwise manipulating rolls of material are well known in the art and are not repeated here. In general, rolls of material are processed, and then are formed and joined to form individual boards. It is understood that the processing may be continuous or may include storing rolls or sheets of partially processed layers for future processing. In addition, it is understood that the equipment shown schematically may also include sensors, positioning equipment, controllers, processors, and other equipment known in the art to facilitate or operate the equipment.

FIG. 8 is a schematic illustrating the process and manufacturing equipment to accept a roll 801 of a material 803, treat and apply a graphics layer 805 on one side of the material, and wind the printed layer 809 into a roll 807. With reference to FIGS. 4 and 5 material 803 may be film 321 and graphics layer 805 may be graphics layer 323, and printed layer 809 is a continuous layer which may be used to form top portion 320. The process of FIG. 8 may be, for example, the step described as Block 601.

The equipment illustrated in FIG. 8 includes a tensioning device 810, a surface treatment device 820, and a graphics transfer device 830. Tensioning device 810 includes a pair of rollers 811 which are operated to transport and maintaining a proper tension of material 803. Surface treatment device 820 accepts and prepares a surface of material 803 for accepting a graphics layer in graphics transfer device 830. In one embodiment, material 803 is a polyethylene film, and surface treatment device 820 exposes the polyethylene film to a coronal discharge. An example of a surface treatment device 820 is a corona treatment system.

In one embodiment, graphics transfer device 830 includes devices to roller print on material 803. Thus, for example, graphics transfer device 830 may include a set of roller for each color to be printed. FIG. 8 shows one of the set of polyethylene film graphic print rollers 831 and a backing roller 843 for a multicolor printing process. In one embodiment, graphics transfer device 830 includes four sets of rollers, each with a different color. The equipment of FIG. 8 produces a continuous or repeating pattern on graphics layer 805.

FIG. 9 is a schematic illustrating the process and manufacturing equipment to accept a roll 901 of a material 903, apply a graphics layer 905 on one side of the material, and wind the printed layer 909 into a roll 907. With reference to FIGS. 4 and 5, material 903 may be fabric layer 331 and graphics layer 905 may be graphics layer 333, and printed layer 909 is a continuous layer which may be used to form bottom printed layer 340. The equipment illustrated in FIG. 9 includes a tensioning device 910 and a graphics transfer device 920. Tensioning device 910 includes a pair of rollers 911 to guide material 903, and is generally similar to tensioning device 810. Graphics transfer device 930 is generally similar to graphics transfer device 930 and prints a multicolor pattern 905 on material 903. In one embodiment, fabric layer 331 includes a non-woven polyethylene fiber material. The process of FIG. 8 may be, for example, the step described as Block 605.

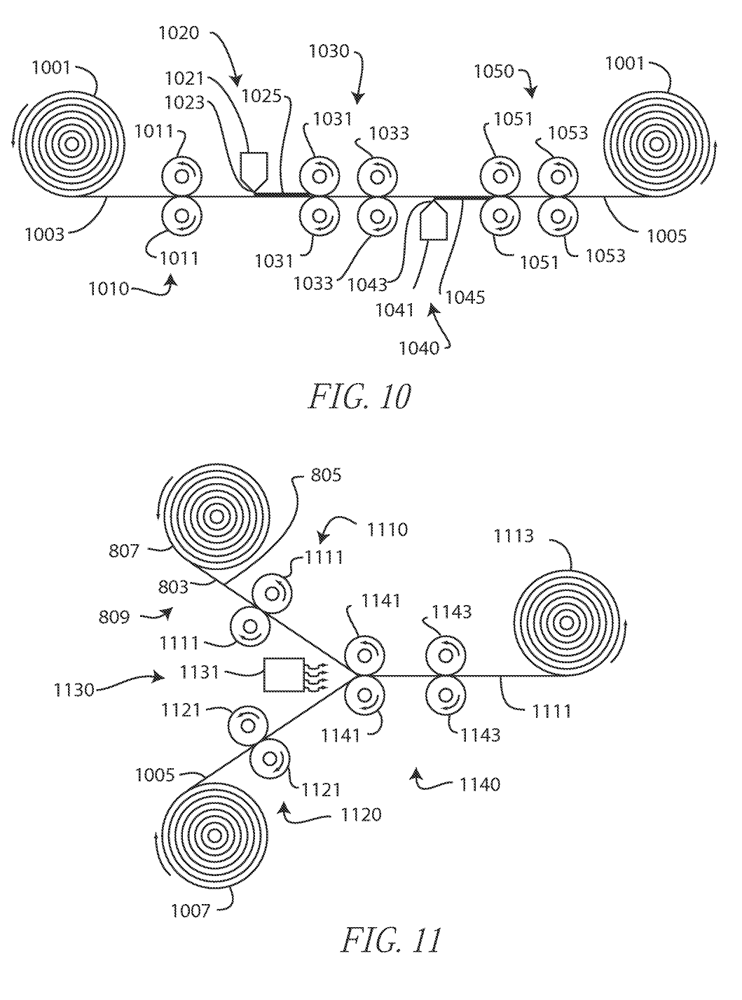

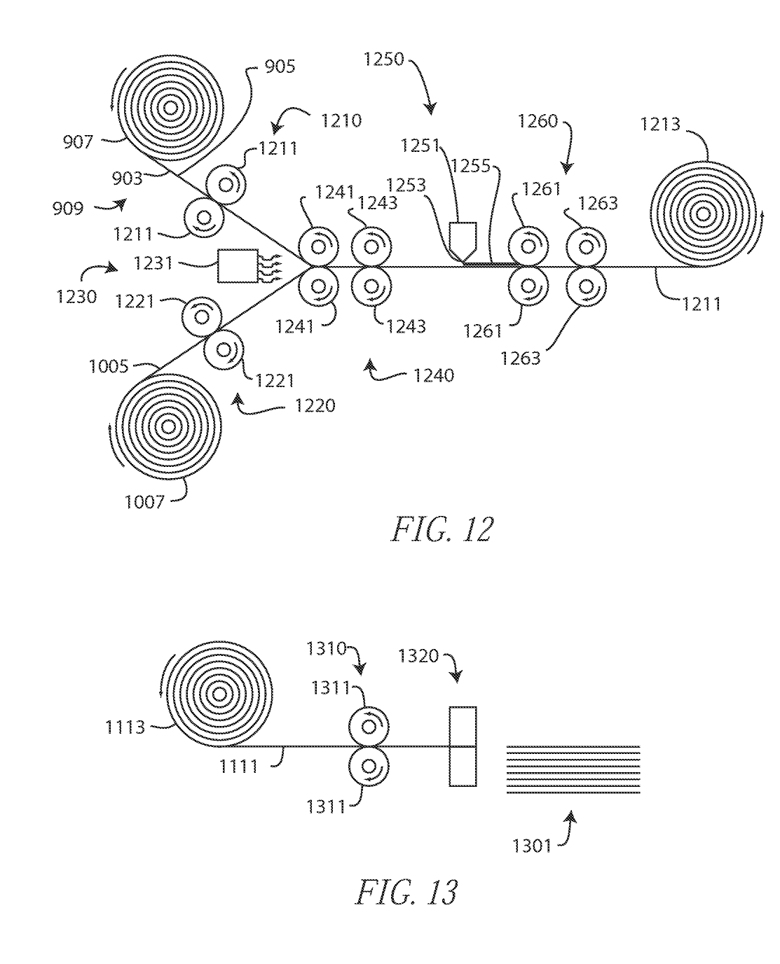

One embodiment of the process of Block 603 is illustrated in FIGS. 10 and 11, and one embodiment of the process of Block 607 is illustrated in FIGS. 10 and 12. As noted above, some materials may be joined directly using heat and pressure, and no adhesive is required. For these materials, including but not limited to polyethylene, the steps of FIG. 10 need not be included in the process. FIG. 10 is a schematic illustrating the process and manufacturing equipment to accept a roll 1001 of a material 1003, apply a layer of adhesive to both sides of the material, and wind the adhesive covered material (material 1105) into a roll 1007. With reference to FIG. 4, material 1003 may be the material of one of 413 or 415, and material 1005 may be one or more of layers 422 and 432. Thus, for example, in one embodiment, layers 422 and 432 have the same structure, and the process of FIG. 10 is carried out once. In another embodiment, layers 422 and 432 have different materials or thicknesses, and the process of FIG. 10 is carried out once for each layer.

The equipment illustrated in FIG. 10 includes a tensioning device 1010, a first adhesive extrusion device 1020, a first adhesive treatment device 1030, a second adhesive extrusion device 1040, and a second adhesive treatment device 1050. Tensioning device 1010 includes a pair of rollers 1011 to guide material 1003, and is generally similar to tensioning device 810. First adhesive extrusion device 1020 includes a heated adhesive material hopper 1021 having an extrusion opening 1021. Device 1020 includes means for accepting adhesive material, heating the material to an appropriate temperature, and forcing the heated materials as layer 1025 onto material 1003. In one embodiment, the adhesive material is a resin, including but not limited to an ethylene vinyl acetate resin, and which flows to form a film of thickness 0.01 mm to 1 mm on material 1003.

First adhesive treatment device 1030 includes rollers 1031 and 1033. One or both of rollers 1031 and 1033 may be cooled or temperature controlled and/or provide pressure to allow the heated adhesive material to cool and form a uniform layer. The adhesive is cooled in conjunction with the rollers as the Pick up rollers is chilled and the thickness is controlled buy the over all speed of the machine.

Second adhesive extrusion device 1040 is generally similar to first adhesive extrusion device 1020, and includes a heated adhesive material hopper 1041 having an extrusion opening 1041, which coats the opposite side of material 1003 with layer 1045. As an example, material 1003 may be material 413, layer 1025 may be adhesive 401, and layer 1045 may be adhesive 405.

FIG. 11 is a schematic illustrating the process and manufacturing equipment to join two materials and to roll the joined surface. Specifically, FIG. 11 accepts a first roll, which may be roll 807 of printed layer 809 and a second roll, which is a corresponding roll 1107, and joins the printed layer to form a corresponding laminated material 1111 which is rolled onto a corresponding roll 1113. With reference to FIG. 4, material 1111 may be layer 420.

The equipment illustrated in FIG. 11 includes a first tensioning device 1110, a second tensioning device 1120, an adhesive activating unit 1130, and laminating rollers 1140. Tensioning device 1110 includes a pair of rollers 1111 to guide printed layer 809, and is generally similar to tensioning device 810. Tensioning device 1120 includes a pair of rollers 1121 to guide material 1005 and is generally similar to tensioning device 810. Adhesive activating unit 1130 includes a heater 1131 that directs hot air at about 300 F (shown as wavy lines) towards the surfaces of printed layer 809 and 1105. Rolls 807 and 1107 are arranged so that the non-printed side of printed layer 809 (material 803) is joined to material 1005.

Laminating rollers 1140 includes a first pair of rollers 1141 and a second pair of rollers 1143 to facilitate laminating of printed layer 809 and material 1005. One or both of rollers 1141 and 1143 may be heated or cooled and/or provide pressure to allow the adhesive (or materials that fuse directly under the application of heat and pressure) to bond the layers passing therethrough.

In an alternative embodiment, one or more of the above steps may be combined without winding rolls between steps. Thus, for example and without limitation, the steps illustrated in FIGS. 8, 10, and 11 may be accomplished in a continuous process by combining the printed layer 809 of FIG. 8 with the material 1005 of FIG. 10 in adhesive activating unit 1130 without forming rolls 807 or 1007.

FIG. 12 is a schematic illustrating the process and manufacturing equipment to join three materials and to roll the joined surface. Specifically, FIG. 12 illustrates accepting a first roll, which may be roll 907 of printed layer 909 and a second roll, which is corresponding roll 1107, and joining the materials of rolls 907 and 1105 and coating with a layer 1255 to form a corresponding laminated material 1211 which is rolled onto a corresponding roll 1213. With reference to FIG. 4, material 1211 may be layer 430.

The equipment illustrated in FIG. 12 is similar to that of FIG. 11, and includes a first tensioning device 1210, a second tensioning device 1220, an adhesive activating unit 1230, laminating rollers 1240. an extrusion device 1250 (if an adhesive layer is required) and rollers 1260. Tensioning device 1210 includes a pair of rollers 1211 to guide printed layer 909, and is generally similar to tensioning device 1110. Tensioning device 1220 includes a pair of rollers 1221 to guide material 1005 and is generally similar to tensioning device 1120. Adhesive activating unit 1230 includes a heater 1231 that directs hot air at about 300 F (shown as wavy lines) towards the surfaces of printed layer 909 and 1105, and is generally similar to adhesive activating unit 1130. Rolls 907 and 1107 are arranged so that the non-printed side of printed layer 809 (material 903) is joined to material 1005.

Laminating rollers 1240 includes a first pair of rollers 1241 and a second pair of rollers 1243 to facilitate laminating of printed layer 909 and material 1005, and is generally similar to laminating rollers 1140.

Extrusion device 1250, which is generally similar to extrusion device 1020, includes a heated adhesive material hopper 1251 having an extrusion opening 1253. Device 1250 includes means for accepting materials to form a clear layer, heating the materials to an appropriate temperature, and forcing the heated materials as layer 1255 onto graphics layer 905. Rollers 1260 include a first pair of rollers 1261 and 1263, which may be cooled and/or provide pressure to form a clear layer on graphics layer 1255. In one embodiment, clear layer 1255 is formed from polyethylene.

In an alternative embodiment, one or more of the above steps may be combined without winding rolls between steps. Thus, for example and without limitation, the steps illustrated in FIGS. 9, 10, and 12 may be accomplished in a continuous process by combining the printed layer 909 of FIG. 9 with the material 1005 of FIG. 10 in adhesive activating unit 1230 without forming rolls 907 or 1007.

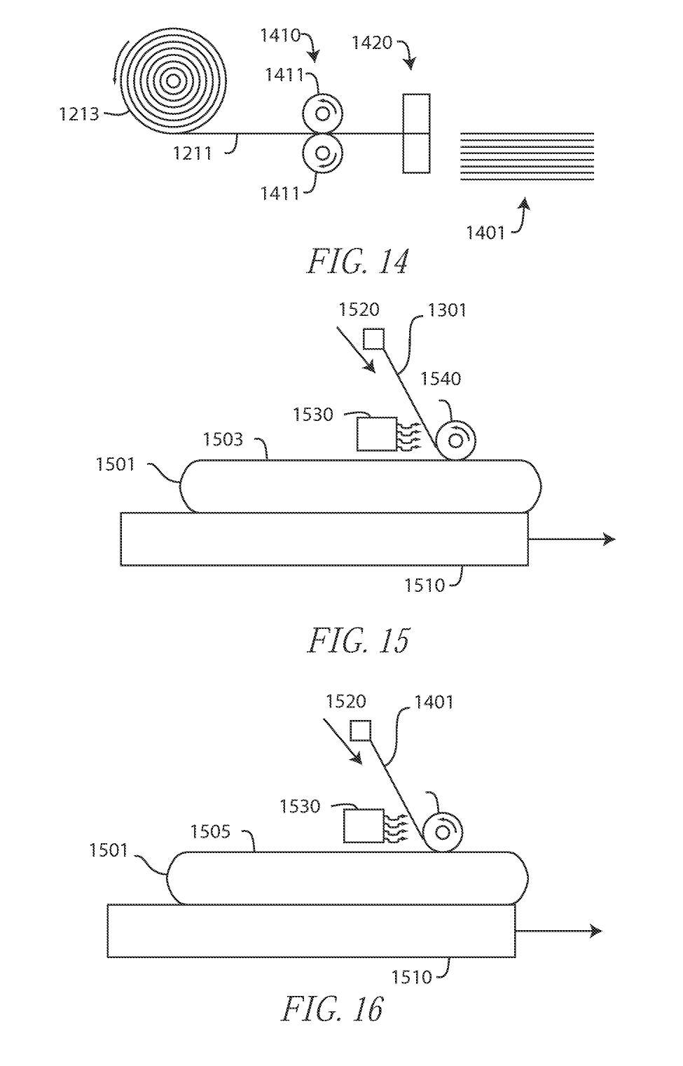

One embodiment of the process of Block 611 is illustrated in FIGS. 13 and 14. FIG. 13 is a schematic illustrating the process and manufacturing equipment to accept a roll 1113 and form plurality of sheets 1301. Each sheet 1301 may be, for example top layer 420. The equipment illustrated in FIG. 13 includes tensioning device 1310, a cutter 1320. Tensioning device 1310 include a pair of rollers 1311 to guide material 1111 into cutter 1320. Cutter 1320 includes a die, knives or saws to cut and shape material 1111 into the shape required for top layer 420 with the proper alignment of graphics layer 323 on the layer. Additional material may be provided for further processing and trimmed to shape at a later step.

FIG. 14 is a schematic illustrating the process and manufacturing equipment to accept a roll 1213 and form plurality of sheets 1401. Each sheet 1401 may be, for example bottom layer 430. The equipment illustrated in FIG. 13 is similar to that of FIG. 14, and includes tensioning device 1410, a cutter 1420. Tensioning device 1410 is generally similar to tensioning device 1310 and includes a pair of rollers 1411 to guide material 1411 into cutter 1420. Cutter 1420 is generally similar to cutter 1320, and cuts and shapes material 1211 into the shape required for bottom layer 430 with the proper alignment of graphics layer 333 on the layer. Additional material may be provided for further processing and trimmed to shape at a later step.

In another step, not illustrated, a center foam material is formed, as in Block 609. The material, shown in FIGS. 15 and 16 as material 1501 having a top surface 1503 and a bottom surface 1505 may be, in reference to FIG. 4, central foam material 411 is formed to the shape required for board 402 and may be molded or extruded and cut to shape.

One embodiment of the process of Block 316 is illustrated in FIGS. 15 and 16. FIGS. 15 and 16 are schematics illustrating the process and manufacturing equipment to join the top and bottom layers to the core. The equipment illustrated in FIG. 15 includes a platen 1510, a sheet manipulation unit 1520, and an adhesive activation unit 1530 and a laminating roller 1540. Adhesive activation unit 1530 includes a heater 1531 and is generally similar to adhesive activation unit 1130, and laminating roller 1540 is generally similar to one or laminating roller 1140. As shown in FIG. 15, material 1501 rests on platen 1510 and an end of sheet 1401 is grasped and manipulated by sheet manipulation unit 1520, with the adhesive layer of sheet 1401 facing surface 1503. Platen 1510 and sheet manipulation unit 1520 are controlled to move in unison, permitting sheet 1401 to be joined to surface 1503. Sheet 1401 is first joined at an edge of surface 1503, and the platen 1510 and sheet manipulation unit 1520 are moved to feed sheet 1401 through adhesive activation unit 1530 and between surface 1503 and laminating roller 1540.

As shown in FIG. 16, material 1501 is then turned over, a sheet 1401 is positioned, with the adhesive layer of sheet 1501 facing surface 1505. and the steps of FIG. 15 are repeated to laminate sheet 1501 on surface 1505. In one embodiment, the laminated structure is board 402. In an alternative embodiment, the methods and equipment of FIGS. 15 and 16 are replaced with a press.

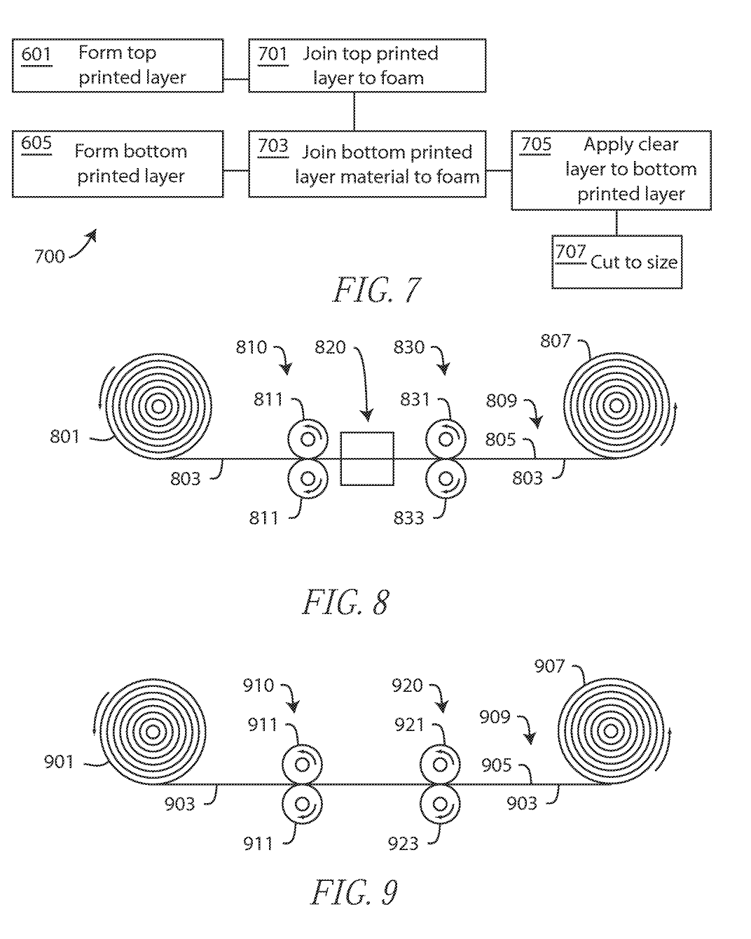

FIG. 7 is a flowchart 700 illustrating one method of manufacturing board 502. The method includes forming different parts of sports board 502, and then joining the in several laminating steps. Where possible, similar elements are identified with identical reference numerals in the depiction of the previous embodiments.

As shown in Block 601 of FIG. 7, top layer 320 is formed. In Block 701 top layer 320 is joined to one side of a backing foam (such as foam material 511). In Block 603 bottom printed layer 340 is formed. In Block 703 bottom printed layer is joined to the opposite side of the backing foam. In Block 705 a clear layer is applied over the printed bottom layer. In Block 707 the board is cut to size. The order of some of these steps may be rearranged in the manufacture of board 502.

One embodiment of flowchart 700 will now be discussed. This process is generally similar to the method described with regard to the flowchart of FIG. 6, except where explicitly stated. Where possible, similar elements are identified with identical reference numerals in the depiction of the previous embodiments. It is understood that this embodiment is one method of manufacturing sports board 502, and other steps, combinations of steps, or order of steps are within the scope of the present invention.

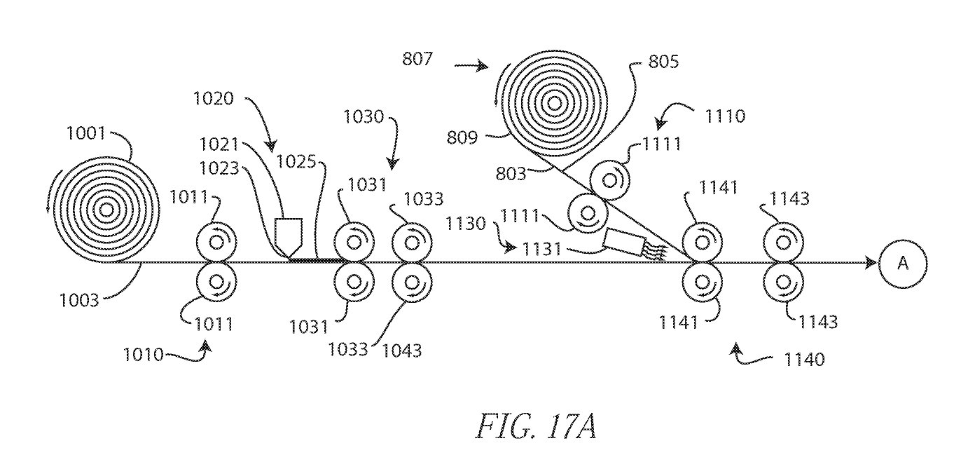

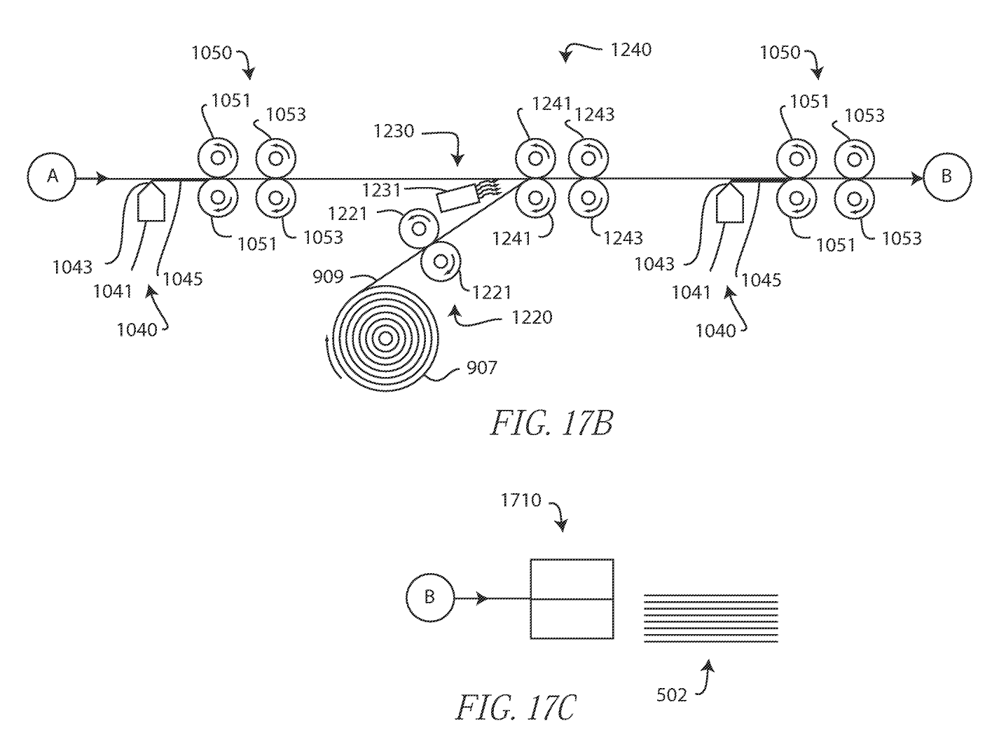

The process of Blocks 601 and 605 of FIG. 7 are described above. In one embodiment, Block 601 produces a roll 807 of printed layer 809, and Block 603 produces a roll 907 of printed layer 909. FIGS. 17A, 17B, and 17C are three consecutive schematics illustrating the process and manufacturing equipment to accept rolls 1001 of material 1003, which may be foam material 511, and rolls 807 and 907 and form a board 502.

FIG. 17A illustrates one embodiment of the processes of Blocks 701. Starting with roll 807 of top portion material, roll 907 of bottom printed layer material, and a roll 1001, which may include foam material 511. First, the material of roll 807 is joined to the material of roll 1001.

Foam material 1003 is unwound from roll 1001, passes through tensioning device 1010, through extrusion device 1020 where adhesive layer 1025 is placed on one side of material 1003, and through a first adhesive treatment device 1030. Roll 807 is unwound with the non-printed side 803 of printed layer 807 facing foam material 1003. Printed layer 807 passes through tensioning device 1110, and past adhesive activating unit 1130, where layer 1025 and layer 807 are heated, and through laminating rollers 1140.

FIG. 17B illustrates one embodiment of the processes of Blocks 703 and 705. The process of FIG. 17A continues from the position marked “A.” The bottom material is joined to the foam (Block 703), as the material passes through adhesive extrusion device 1040 where layer 1045 of adhesive is applied and passes through second adhesive treatment device 1050. Roll 907 is unwound with the non-printed side of printed layer 907 facing foam material 1003. Printed layer 907 passes through tensioning device 1110, and past adhesive activating unit 1230, where layer 1045 and layer 907 are heated, and through laminating rollers 1240.

A clear layer is applied to the bottom printed layer (Block 705) as the material passes through extrusion device 1250, where layer 1255 is applied to the printed side of the non-woven fabric, and through rollers 1260.

FIG. 17C illustrates one embodiment of the process of Block 707. The process of Block 17B continues from the position marked “B.” The material passes through die 1710 which stamps out the shape of board 502, which are accumulated as shown. In one embodiment, the stamping of the board occurs during the process illustrated in FIGS. 15 and 16, as the die cutting (Stamp) of the shape is completed just after the bottom is laminated to the core, and then the deck is laminated onto the top of the core.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Thus, while there has been described what is believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

We claim:

1. A method of providing graphics to a sports board having a foam core, where said foam core has a first side and an opposing second side, said method comprising:
providing a graphics layer to a first surface of a material, where said material has a second surface opposing said first surface; and
joining said second surface of said material to the first side of the foam core,
where said graphics layer forms at least part of an outer surface of said sports board.

2. The method of claim 1, where said providing includes roller printing said graphics layer to said first surface.

3. The method of claim 2, further comprising coronal treating said first surface prior to roller printing said film.

4. The method of claim 1, where said material includes a polyethylene film.

5. The method of claim 4, where said polyethylene film has a thickness of from 0.01 mm to 2 mm.

6. The method of claim 1, where the foam core includes a foam having a density of from approximately 1 pound per cubic foot to approximately 10 pounds per cubic foot.

7. The method of claim 6, where the foam core has a thickness of from approximately 1 mm to approximately 5 mm.

8. The method of claim 1, where the foam core includes a polyethylene foam.

9. The method of claim 1, where the foam core includes a cross-linked polyethylene foam.

10. The method of claim 1, where said joining includes adjoining with an adhesive.

11. The method of claim 10, where said adhesive is a resin.

12. The method of claim 1, where said joining includes heating said film.

13. The method of claim 1, where said graphics layer is a first graphics layer, further comprising:
providing a second graphics layer to a first surface of a fabric, where said fabric has a second surface opposing said first surface; and
joining said second surface of said fabric to the second side of the foam core.

14. The method of claim 13, where said fabric is a non-woven material.

15. A method of providing graphics to a sports board having a foam core, where said foam core has a first side and an opposing second side, said method comprising:
joining a material to a front side of the foam core, where said material includes a first graphics layer facing away from the foam core;
joining a fabric to a back side of the foam core, where said fabric includes a second graphics layer facing away from the foam core,
where said first graphics layer forms at least part of an outer surface of said sports board.

16. The method of claim 15, further comprising roller printing said first graphics layer.

17. The method of claim 15, further comprising coronal treating said material prior to roller printing said first graphics layer.

18. The method of claim 15, where said material includes a polyethylene film.

19. The method of claim 18, where said polyethylene film has a thickness of from 0.01 mm to 2 mm.

20. The method of claim 15, where the foam core includes a foam having a density of from approximately 1 pound per cubic foot to approximately 10 pounds per cubic foot.

21. The method of claim 15, where the foam core has a thickness of from approximately 1 mm to approximately 5 mm.

22. The method of claim 15, where the foam core includes a polyethylene foam.

23. The method of claim 15, where the foam core includes a cross-linked polyethylene foam.

24. The method of claim 15, where said joining includes adjoining with an adhesive.

25. The method of claim 24, where said adhesive is a resin.

26. The method of claim 15, where said joining includes heating said film.

27. The method of claim 15, where said fabric is a non-woven material.
